(19) United States
(12) Patent Application Publication
(10) Pub. No.: US 2009/0313074 A1
(43) Pub. Date: Dec. 17, 2009

(54) ENHANCED VIEWING/UPDATING OF CALENDAR ENTRIES BASED UPON RELATIONSHIPS BETWEEN A VIEWER AND A CALENDAR OWNER AND A RELATIVE IMPORTANCE VALUE OF THE CALENDAR ENTRIES

(75) Inventors: LIAM HARPUR, SKERRIES (IE); CORMAC O'LEARY, EDENDERRY (IE); PATRICK J. O'SULLIVAN, BALLSBRIDGE (IE); HEMA SRIKANTH, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/137,010

(22) Filed: Jun. 11, 2008

(51) Int. Cl. G06Q 10/00

(52) U.S. Cl. 705/9

(57) ABSTRACT

A calendar of a calendar owner can be identified. The calendar can include at least one calendar entry. Each calendar entry can be associated with access restrictions specific to the entry and/or a type associated with the entry. An attempt from a non-owner to access the calendar of the owner can be received. A relationship between the non-owner and the owner can be determined, which is used to grant access privileges. A non-owner can be permitted to access/change the owner's calendar entries based upon comparisons of the granted privileges and the access restrictions. For example, when certain approved people view busy-time scheduled in a user's calendar, any non-important booked time can be shown as time availably for scheduling events with the user. When an approved person schedules a previously book time slot, and an owner agrees to this change, then existing appointments are automatically rescheduled/adjusted to avoid conflicts.

### BACKGROUND OF THE INVENTION

The present invention relates to the field of scheduling, more particularly to enhanced viewing/updating of calendar entries based upon relationships between a viewer and a calendar owner and a relative importance value of the calendar entries.

Many computing applications provide users with a shared calendar. Some applications implement shared calendars where users get their own calendars and others can implement a common calendar for multiple users to share. Often, both private and group calendars can be provided in collaborative software. Collaborative software is also used in social networking settings and other settings where a distributed set of people need to coordinate with each other.

When personal calendars for users are provided, they can typically be shared with other users. When other users view shared calendars, they can see which time is scheduled and what time the user has free. In one example, a shared calendar can be used in a professional environment. Each employee's calendar can reflect their schedule for their daily activities at work. The employee's calendar can also reflect instances where personal time has been scheduled. Regardless of who views the calendar, the viewer will see all the scheduled time in a unified manner. A user, however, may desire their boss in a business context or their spouse in a personal context to have enhanced viewing and/or calendar manipulation options available for calendaring events. For example, a boss would have access to change/view business related meeting events of an owner's. In another example, a spouse would have similar leeway for family related scheduled events within an owner's calendar. Conventional calendaring systems do not customize calendar actions based upon a relationship between an owner and an accessing party. Additionally, existent calendaring systems make no distinctions between different types of calendar entries

### BRIEF SUMMARY OF THE INVENTION

One aspect of the present invention can include a collaborative calendaring system that includes a data store, a categorization engine, an event scheduling engine, a relationship engine, and/or other functional components. The data store can digitally encode calendar data specifying a set of calendar entries associated with different calendar owners. The calendaring engine can distinguish between calendar entries representing genuine meetings and user created time blocks set aside to permit an owner of the calendar to complete a task. The event scheduling engine can permit non-owners to push new calendar entries into an owner's calendar even when the new calendar entries conflict with at least one of previously established entries for a time block set aside to permit the owner of the calendar to complete a task. The pushing of a new calendar entry to a calendar of an owner does not necessarily require explicit owner permission to be granted at a time that the pushing of the new calendar entry occurs.

Another aspect of the present invention can include a method, computer program product, an apparatus, and a system for selectively sharing calendars in a collaborative computing space. In this aspect, a calendar of a calendar owner can be identified. The calendar can include at least one calendar entry. Each calendar entry can be associated with access restrictions specific to the entry and/or a type associated with the entry. For example, entries in a calendar representing user-set aside time to complete a task can have different (e.g., lesser) access restrictions than a calendar entry associated with meeting having multiple attendees. An attempt from a non-owner to access the calendar of the owner can be received. A relationship between the non-owner and the owner can be determined. Access privileges for the non-owner can be determined based at least in part upon the determined relationship. The access privileges can be compared to the access restrictions of each calendar entry. The non-owner can be permitted to access to the calendar entries based upon results of the comparing operation. For example, the comparing operation can permit a non-owner to push new calendar entries into an existing time slot partially occupied by a “task completing” entry, where other calendar entries (such as those associated with a meeting) can be viewed but not modified.

### BRIEF DESCRIPTION OF THE SEVERAL VIEWS OF THE DRAWINGS

FIG. 1 is an example scenario for selectively granting different access permissions to an owner's calendar based upon an accessing user's relationship with the owner and based upon details of specific calendar entries in accordance with an embodiment of the inventive arrangements disclosed herein.

FIG. 2 is a schematic diagram of a system for selectively sharing calendar entries in a collaborative computing space, where the sharing varies based upon a relationship between a calendar owner and a user.

FIG. 3 is a flow chart of a method for selectively sharing calendars in a collaborative computing space in accordance with an embodiment of the inventive arrangements disclosed herein.

### DETAILED DESCRIPTION OF THE INVENTION

The present invention can allow for the categorization of calendar entries. The calendar entries can have different important levels associated with them, for example, entries relating to meetings with others can have a higher import level (or priority level) than to-do time slot blocked by a calendar owner to accomplish a task (e.g., a to-do item). A “relationship strength” can be determined between an accessing user of another user's calendar. A user's relationship and/or relationship strength can be determined in multiple ways. For example, a strength can be based upon a relative placement of the user verses a calendar owner in an organizational hierarchy. In another example, relationship strength can be determined based upon a connectively strength within a social network. A comparison between the relationship strength and the import level of a calendar entry can determine whether the user can view/change the calendar entry.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

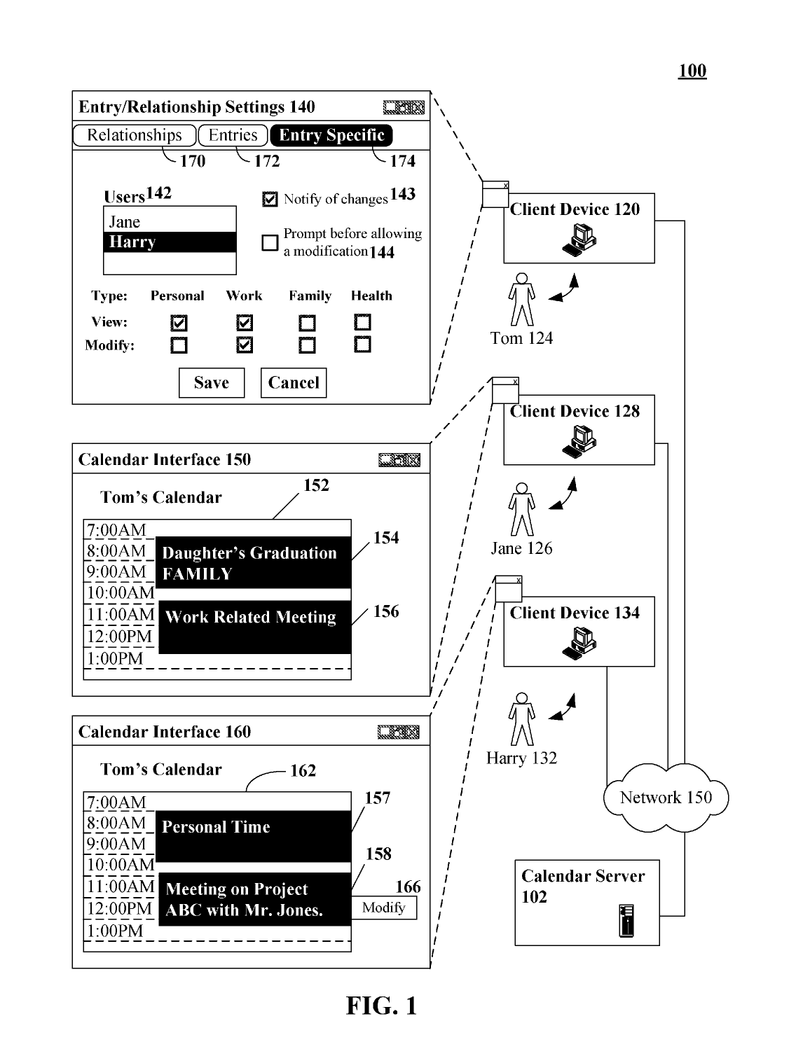

FIG. 1 is an example scenario 100 for selectively granting different access permissions to an owner's calendar based upon an accessing user's relationship with the owner and based upon details of specific calendar entries in accordance with an embodiment of the inventive arrangements disclosed herein. Scenario 100 can include users 124 (Tom), 126 (Jane), and 132 (Harry). The users 124, 126, and 132 can each interact with client devices 120, 128, and 134 having user interfaces 140, 150, and 160. Each of the devices 120, 128, and 134 can be connected to calendar server 102 through network 150. System 100 shows a situation where an owner's 124 (Tom's) calendar entries are able to be selectively viewed/changed by one or more other users 126, 132 based upon a relationship among users 124, 126, 132 and based upon an importance value associated with calendar entries 154, 156.

As shown, Tom 124 can interact with calendar server 102 to configure specifics of his calendar. For example, interface 140 can permit an owner (Tom) 124 to establish entry/relationship settings. A selectable tab for relationships 170 can, for example, permit an owner to dictate how relationships and/or relationship strength values are to be determined for purposes of granting access to the owner's calendar entries. Another selectable tab for entries 172 can establish customizations for determining restrictions that are to be imposed upon calendar entries, such as restrictions based upon calendar entry type (meeting, to-do item, etc), category (work related entry, family related entry, etc.), and other definable criteria. An entry specific tab 174, which is shown as highlighted, can permit the owner to establish entry specific settings regarding access to be granted to others for a specific calendar entry. When more generic settings exist, the specific settings established via tab 174 can override. In another implementation, a most restrictive or most permissive set of access rules can be applied when conflicts among specific and generalized settings are resolved.

Entry specific settings 172 can include a selectable control for establishing relationships with other users 142 and for granting variable permissions to these users based upon a type of calendar entry (types shown in interface 140 includes personal, work, family, and health—although any type can be utilized). The interface 140 is also configured using option 143, to notify the calendar owner (Tom 124), when calendar changes are made. Other options can be included, such as an option 144 to prompt a calendar owner before allowing others to modify a calendar entry. Based on the settings established in interface 140, the calendar server 102 can establish proper permissions for other users 126, 132 accessing Tom—s 134 calendar.

Tom's 124 calendar 152, 162 can be viewed by Jane 126 and Harry 132 using interfaces 150 and 160. Jane 126 can be related to Tom 124 by birth or marriage. Family based relationships can be granted view only access to entries on Tom's calendar related to work and view only access to family related entries. In one embodiment, work related entries can be abstracted (or redacted) as shown in entry 156 to hide details, which may be confidential. Details of the personal or family related entries 154 can be presented in full for viewing, in accordance with permissions configured by the calendar owner 124 (using interface 140).

Harry 132 can have a work-related supervisory relationship with Tom 124 (e.g., Harry 132 can be Tom's boss, supervisor, project leader, etc.). This relationship can grant Harry 132 view permissions over portions of Tom's 124 calendar (such as personal entries for Tom 124 can be viewed by Harry 132 as shown in interface 140) and modify privileges against other portions (e.g., work related entries). In one embodiment, details of entries not related to work can be obscured, as shown by entry 157, which is marked as personal time. Full details can be provided for a work related entry, as shown by calendar entry 158. Selection of a modify 166 option permits Harry 132 to manipulate details of the work related entry 158. For example, Harry 132 can add a different work related meeting for the time of 11:00AM-12:00PM and can reschedule the original meeting having that time slot (entry 158) for a different time.

It should be appreciated that explicit relationship and permissions as shown in system 100 is one contemplated embodiment of the invention. In another embodiment, a calendar owner 124 will not explicitly establish per person privileges, but can establish various privileges for calendar entries based upon a relationship type and strength. The relationship type and strength can be determined based upon relatively static information (e.g., being based upon positions in an organization hierarchy) as well as being based upon dynamic information (e.g., a frequency of communication between two users within a social network). Additionally, a set of owner configurable rules can be used to categorize different types of events and to apply an importance level to events based upon these categories. For example, to-do items appearing in a calendar can be given a lower importance level than meeting events.

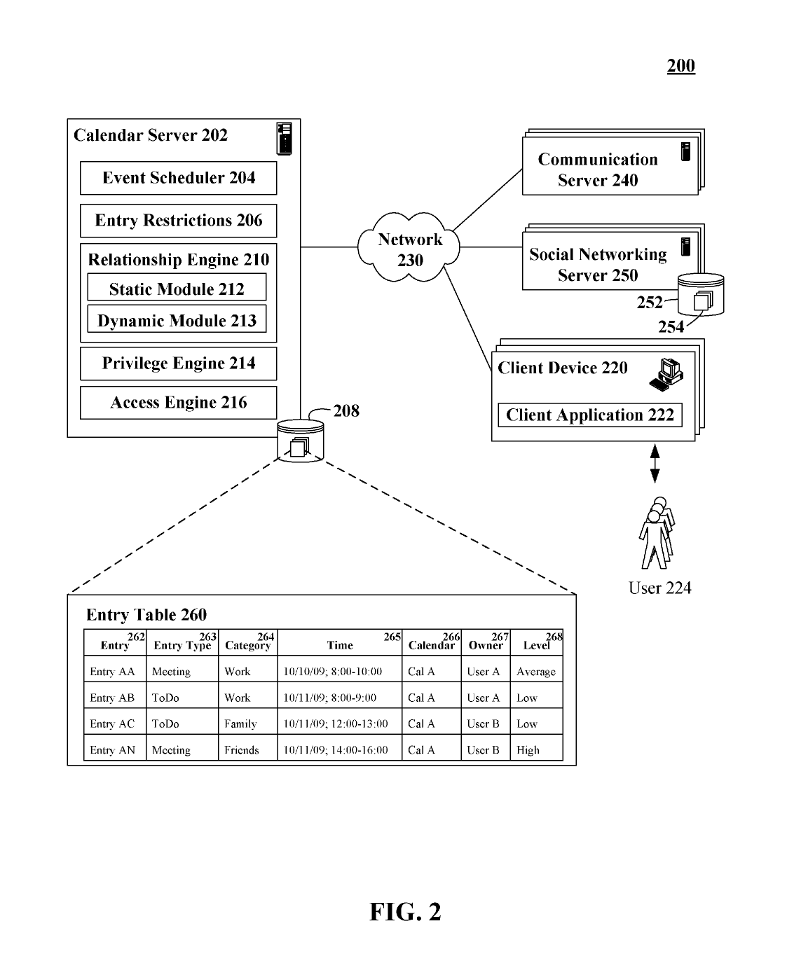

FIG. 2 is a schematic diagram of a system 200 for selectively sharing calendar entries in a collaborative computing space, where the sharing varies based upon a relationship between a calendar owner and a user. In system 200, a calendar server 202 can manage calendar entries for a plurality of users 224. Each calendar entry can be associated with an owner, who is the user 224 for whom the calendar entry applies. Other users 224 can view/modify the owner's calendar entries depending upon their relationship with the owner and depending upon specifics of the calendar entries themselves.

An event scheduler 204 component of the calendar server 202 can permit managed events to be added, removed, and modified within an associated calendar. For example, the scheduler 204 can permit a non-owner to push new entries to an owners calendar (assuming suitable access rights are granted to the non-owner) even when the new entry conflicts with a pre-existing entry. The scheduler 204 can automatically reschedule, change times of, calendar entries to resolve conflicts caused by the new entry. In one embodiment, non-owners can push times for meetings into time slots otherwise allocated towards “scheduled free time” or toward a user completion of a to-do item. Different types of entries (meetings, scheduled free time, solitary tasks, personal time, etc.) can have different priorities and/or importance scores associated with them, which can prevent/permit non-owners from modifying pre-existing calendar entries. In one embodiment, a calendar owner can explicitly establish an importance score/access level for a given entry (as shown in interface 140). When entry specific settings are established, more generic settings such as category specific restrictions, can be superseded.

Each of the entries of a calendar can have a set of associated access restrictions, which are handled by the entry restriction component 206. A relationship engine 210 can determine a relationship between an entry owner and a user 224 attempting to access a calendar entry of the owner. Relationships can be based upon static considerations, handled by static module 212, as well as dynamic considerations, handled by dynamic module 213. Given a relationship, determined by engine 210, a privilege engine 214 can determine a set of privileges that are to be granted based upon the relationship 214. An access engine 216 can compare entry restrictions against user privileges, and can grant appropriate access to the calendar entries. Calendar server 202 can serve calendar entries to remotely located devices 220/applications 222 based upon access rights established by access engine 216.

The server 202 can also include a data store 208, which stores calendar entry information, user 224 profile information, security information, and the like, which is utilized by the calendar server 202. The data store 208 can maintain multiple different tables, such as entry table 260. Entry table 260 can store multiple different values for each calendar entry. Each entry 260 can include, for example, an entry identifier 262, an entry type 263, an entry category 264, an entry time 265, an associated calendar 266, an owner 267, and an entry specific access level 268. These attributes 262-268 are for illustrative purposes only and are not to be construed as a limitation on the invention.

The entry attribute 262 can represent a primary key that is unique for a calendar entry. An entry type 263 can include whether an entry is for an actual meeting, for a reminder, for a to-do item, and the like. An actual meeting can be a meeting that includes two or more people. A to-do item can include a time block set aside by a calendar owner to accomplish a task. A category 264 can represent a context to which the calendar entry applies, such as work, friends, hobby, family, and the like. The time 265 can be the time range/associated with the entry. The calendar 266 can be a foreign key that associates the entry with a specific calendar object. The owner 267 can be a person for whom the calendar entry 262 is maintained. The level 268 can refer to a restriction level associated with an individual entry. The level 268 can include a set of levels (low, average, high) or can be presented as a score or importance value associated with a related entry. The value of the level 268 can be compared against a relative privilege level (from engine 216) of a user 224 to determine what access rights a given user has against a particular calendar entry 262.

Users 224 can access the calendar server over network 230 using a client device 220. The device can include an application 222 for interacting with the server 202. The application 222 can be a client-side calendaring application and/or a Web browser that renders a Web application (served calendar, which includes a set of calendar entries). In one embodiment, one or more communication servers 240 can be used as communication intermediaries between the device 220 and the calendar server 202. For example, a voice response system (provided by a communication server 240) can permit a user 224 to interact with a calendar server 202 via a telephony device and a voice user interface (VUI). The communication server 240 can also include an email server, an instant messaging server, and the like that communicates notifications to an owner when changes to the owner's calendar entries occur.

In one embodiment, a relationship among users 224 can be based upon a strength of their relationship as determined by social networking interactions. For example, users 224 can exchange communications 254 stored in data store 252 using a social networking server 250. This server 250 can be connected to the calendar server 202 via network 230. More specifically, the dynamic module 213 of the relationship engine 210 can apply a set of rules to determine a relationship/relationship strength based upon data 254 stored and maintained by social networking server 250. A relationship/relationship strength can also be based upon more static factors, such as a supervisory relationship within an organization hierarchy, a consanguinity or affinity (e.g., relationship by marriage) relationship, and the like, which can be handled by static module 212. In one embodiment, static and dynamic factors can be combined into a hybrid relationship/relationship strength, which is used to determine a set of access rights to be granted to a given user 224 for a set of calendar entries of another.

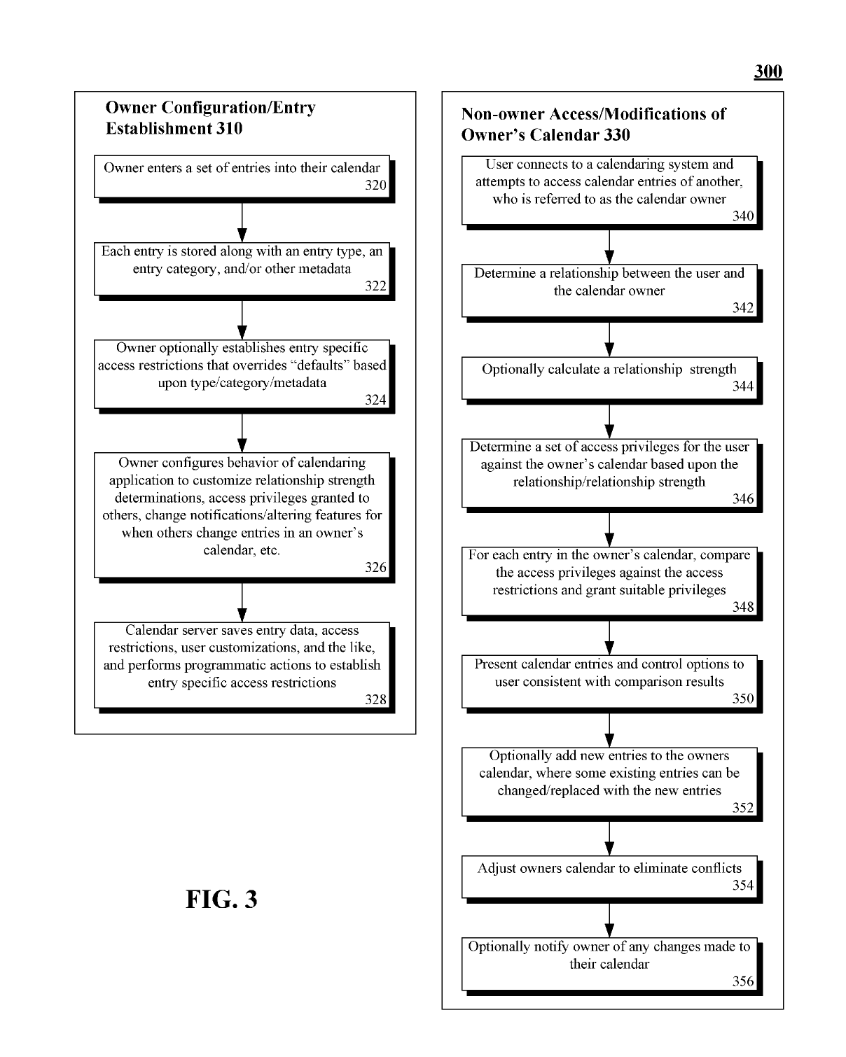

FIG. 3 is a flow chart of a method 300 for selectively sharing calendars in a collaborative computing space in accordance with an embodiment of the inventive arrangements disclosed herein. The method 300 can be performed in context of a system 200 or similar system. Method 300 shows two distinct processes, which can occur asynchronously; one being a process 310 for owner establishment of calendar entries and/or of owner configuration of access privileges for entries as well as configuration of calendaring system customizations; the other being a process 330 where a non-owner accesses/modifies an owner's calendar entries.

Process 310 can begin in step 320, where an owner enters a set of one or more calendar entries into their calendar. Each entry can be stored along with entry details, an entry type, and entry category, and other entry specific metadata, as shown in step 322. In step 324, the owner can optionally establish entry specific access restrictions for calendar entries that override “defaults” based upon entry type, category, or other metadata. In step 326, the owner can configure behavior of the calendar application to customize relationship strength determinations, access privileges granted to others, change notification/alerting features for when others change entries in an owner's calendar, etc. In step 328, a calendar server can save the entry specific data, the entry access restrictions, and the user customizations. Programmatic actions can be performed per entry to determine a set of access restrictions for each of the calendar entries, where these determinations are based upon programmatic rules driven by entry type, category, etc. Different access restrictions can apply to different users attempting to access the calendar entries based at least in part upon a relationship between the owner and the accessing user.

Process 330 can begin in step 340, where a user connects to a calendaring system and attempts to access calendar entries of another user, who is referred to as a calendar owner. In step 342, a relationship between the user and the calendar owner can be determined. In step 344, a relationship strength can be optionally calculated. The relationship strength/type can be based upon relative static and/or relatively dynamic factors. Static factors can include, for example, consanguinity bonds and legal family bonds and an relative placement/relationship within an organizational hierarchy (e.g., boss-subordinate relationships). Dynamic relationships can be based upon a frequency of contacts/strength, which can be determined based upon social networking techniques and communications. For example, a relationship strength of a “friendship” can be considered relatively strong when many communications are exchanged between two parties and considered relatively weak when few communications are exchanged. In step 346, a set of access privileges for the user against the owner's calendar can be determined based upon the relationship/relationship strength. In step 348, for each entry in the owner's calendar, the access privileges for the user can be compared against access restrictions for those entries and suitable privileges can be granted based upon comparison results.

In one embodiment, communication/relationship content can be analyzed so that a relationship strength is evaluated within a specific context. For example, a strength of communications can be specific to a particular project, organization, hobby and the like, where outside of this context, a weaker relationship exists. These context can be compared against context of a related calendar entry (if the entry is for a hobby then a relationship strength will be based upon/biased for that hobby; if an entry is for a work project then a relationship strength will be based upon/biased for that project; etc.) A level of granularity and complexity used for determining relationship strength/context is arbitrary and will vary based upon implementation specific choices and goals.

In step 350, calendar entries and control options can be provided to the user/presented within an interface being used by the user which are consistent with the comparison results. In step 352, the user can optionally add new entries to the owner's calendar. Some of the existing entries (depending upon granted privileges) can be changed/modified/replaced with the new entries. In step 354, the owner's calendar can be adjusted to eliminate conflicts. For example, if a new entry conflicted with owner scheduled time to complete a task, the task completion time entry can be rescheduled/adjusted so that it does not conflict with the new entry. Owner configured settings can be optionally used, which dictate a manner in which the calendaring system performs conflict resolving adjustments. In step 356, a calendar owner can be optionally notified of any changes made to their calendars.

To illustrate process 330 using a concrete example, a non-owner can attempt to view an owner's calendar. The non-owner can be presented with entries showing busy-time, which is scheduled but still available to the non-owner (based upon strength of relationship between the non-owner and the owner). The non-owner can establish a new meeting with the owner in a slot at least partially labeled as busy-time. When the owner views his calendar, any non-owner meetings can be labeled as “pushed requests” to indicate that another has “pushed”a meeting into a time-slot that was previously occupied. A calendar owner can approve this new meeting, which can result in the busy-time being automatically rescheduled/canceled.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A calendaring system comprising:
a data store configured to digitally encode calendar data specifying a plurality of calendar entries associated with plurality of different calendar owners;
an entry restrictions component configured to distinguish between calendar entries representing genuine meetings and user created time blocks set aside to permit an owner of the calendar to complete a task; and
an event scheduling engine configured to permit non-owners to push new calendar entries into an owners calendar even when the new calendar entries conflict with at least one of previously established entries for a time block set aside to permit the owner of the calendar to complete a task, wherein a pushing of a new calendar entry to a calendar of an owner does not require explicit owner permission to be granted at a time that the pushing of the new calendar entry occurs.

2. The calendaring system of claim 1, wherein the event scheduling engine is configured to automatically reschedule calendar entries responsive to a push of a new calendar entry by a non-owner so that a calendar to which the new calendar entry has been added does not include calendar entries that conflict with one another.

3. The calendaring system of claim 1, further comprising:
a relationship engine configured to determine a relationship between a non-owner attempting to access a calendar entry of an owner and the owner;
a privilege engine configured to determine a set of privileges to be granted to a non-owner based upon a relationship determined by the relationship engine; and
an access engine configured to compare the set of privileges determined by the privilege engine against entry specific restrictions determined by the entry restrictions component to determine access rights to be granted to calendar entries.

4. The calendaring system of claim 3, said relationship engine further comprising:
a static module configured to determine the relationship between the non-owner and the owner based upon relatively static factors; and
a dynamic module configured to determine the relationship between the non-owner and the owner based upon communication factors of a social network within which the non-owner and the owner communicate.

5. The calendaring system of claim 3, wherein said relationship engine is configured to determine a relationship strength, wherein the entry restrictions is configured to determine an entry level, wherein the access engine compares the relationship strength to the access level for each calendar entry to determine access rights to be granted to the non-owner for each calendar entry of the owner.

6. A method for selectively sharing calendars in a collaborative computing space comprising:
identifying a calendar of a calendar owner, said calendar comprising at least one calendar entry, wherein each calendar entry is associated with access restrictions;
receiving an attempt from a non-owner to access the calendar of the owner;
determining a relationship between the non-owner and the owner;
determining access privileges for the non-owner based at least in part upon the determined relationship;
comparing the access privileges to the access restrictions of each calendar entry; and
permitting the non-owner to access to the calendar entries based upon results of the comparing.

7. The method of claim 6, wherein the at least one calendar entry comprises a plurality of calendar entries, said method further comprising:
programmatically distinguishing among the plurality of calendar entries based in part upon whether each of the calendar entries is associated with a meeting or is a calendar time block established to permit the owner to complete a task; and
assigning a higher priority to those calendar entries associated with a meeting relative to those calendar entries representing a calendar time block to permit the owner to complete a task, wherein the determined access privileges grant the non-owner an ability to schedule meetings using the calendar of the owner during time periods at least partially blocked off to permit the owner to complete a task, wherein the determined access privileges do not grant the non-owner an ability to schedule calendar entries during time periods at least partially blocked off for a previously established meeting.

8. The method of claim 7, further comprising:
presenting the non-owner with an option to modify at least one of the calendar entries associated with a calendar time block to permit the owner to complete a task;
receiving a new calendar entry from the non-owner that adds a new entry to the calendar, which at least partially conflicts temporally with an existing one of the calendar entries associated with a calendar time block to permit the owner to complete a task;
adding the new calendar entry to the calendar of the owner; and
adjusting the calendar entry conflicting with the new entry so that no conflict exists, wherein the adding and adjusting steps occur without requiring an explicit interactions between a calendaring system and the owner.

9. The method of claim 8, further comprising:
notifying the owner of the change to the calendar.

10. The method of claim 6, further comprising:
determining the relationship between the non-owner and the owner based upon at least one of: a consanguinity relationship, an affinity relationship, and a relationship by positions held by the non-owner and the owner within an organizational hierarchy.

11. The method of claim 6, further comprising:
determining a relationship between the non-owner and the owner based upon social networking system data and a relationship strength between the non-owner and the owner based within a social networking system.

12. The method of claim 6, further comprising:
determining a restriction level for each calendar entry;
determining a privilege level for the non-owner based upon the determined relationship;
programmatically comparing the determined restriction level and the determined privilege level to generate a set of access rights for each calendar entry; and
permitting the non-owner access to calendar entries based upon the generated set of access rights, wherein different ones of the entries have different associated access rights.

13. A computer program product for selectively sharing calendars in a collaborative computing space comprising:
a computer usable medium having computer usable program code embodied therewith, the computer usable program code comprising:
computer usable program code configured to identify a calendar of a calendar owner, said calendar comprising at least one calendar entry, wherein each calendar entry is associated with access restrictions;
computer usable program code configured to receive an attempt from a non-owner to access the calendar of the owner;
computer usable program code configured to determine a relationship between the non-owner and the owner;
computer usable program code configured to determine access privileges for the non-owner based at least in part upon the determined relationship;
computer usable program code configured to compare the access privileges to the access restrictions of each calendar entry; and
computer usable program code configured to permit the non-owner to access to the calendar entries based upon results of the comparing.

14. The method of claim 13, wherein the at least one calendar entry comprises a plurality of calendar entries, said method further comprising:
computer usable program code configured to programmatically distinguish among the plurality of calendar entries based in part upon whether each of the calendar entries is associated with a meeting or is a calendar time block established to permit the owner to complete a task; and
computer usable program code configured to assign a higher priority to those calendar entries associated with a meeting relative to those calendar entries representing a calendar time block to permit the owner to complete a task, wherein the determined access privileges grant the non-owner an ability to schedule meetings using the calendar of the owner during time periods at least partially blocked off to permit the owner to complete a task, wherein the determined access privileges do not grant the non-owner an ability to schedule calendar entries during time periods at least partially blocked off for a previously established meeting.

15. The method of claim 14, further comprising:
computer usable program code configured to present the non-owner with an option to modify at least one of the calendar entries associated with a calendar time block to permit the owner to complete a task;
computer usable program code configured to receive a new calendar entry from the non-owner that adds a new entry to the calendar, which at least partially conflicts temporally with an existing one of the calendar entries associated with a calendar time block to permit the owner to complete a task;
computer usable program code configured to add the new calendar entry to the calendar of the owner; and
computer usable program code configured to adjust the calendar entry conflicting with the new entry so that no conflict exists, wherein the adding and adjusting steps occur without requiring an explicit interactions between a calendaring system and the owner.

16. The method of claim 15, further comprising:
computer usable program code configured to notify the owner of the change to the calendar.

17. The method of claim 13, further comprising:
computer usable program code configured to determine the relationship between the non-owner and the owner based upon at least one of: a consanguinity relationship, an affinity relationship, and a relationship by positions held by the non-owner and the owner within an organizational hierarchy.

18. The method of claim 13, further comprising:
computer usable program code configured to determine a relationship between the non-owner and the owner based upon social networking system data and a relationship strength between the non-owner and the owner based within a social networking system.

19. The method of claim 13, further comprising:
computer usable program code configured to determine a restriction level for each calendar entry;
computer usable program code configured to determine a privilege level for the non-owner based upon the determined relationship;
computer usable program code configured to programmatically compare the determined restriction level and the determined privilege level to generate a set of access rights for each calendar entry; and
computer usable program code configured to permit the non-owner access to calendar entries based upon the generated set of access rights, wherein different ones of the entries have different associated access rights.
